(19) United States
(12) Patent Application Publication
(10) Pub. No.: US 2002/0145268 A1
(43) Pub. Date: Oct. 10, 2002

(54) Trailer hitch guide

(76) Inventor: Carl A. Zechbauer, Mahtomedi, MN (US)

Correspondence Address: SHERRILL LAW OFFICES, 4756 BANNING AVE, SUITE 212, WHITE BEAR LAKE, MN, 55110-3205, US

(21) Appl. No.: 09/828,102

(22) Filed: Apr. 6, 2001

(51) Int. Cl. B60D 1/00

(52) U.S. Cl. 280/477; 280/504

(57) ABSTRACT

A trailer hitch guide assembly that effectively elevates and guides a forward end of a trailer hitch into coupling engagement with a vehicle hitch. The trailer hitch guide assembly of the present invention elevates the forward end of the trailer hitch and guides the forward end of the trailer hitch into alignment with a coupling of the vehicle hitch. When the trailer hitch engages a support arm of the guide assembly, the trailer hitch is lowered, wherein a coupling of the trailer hitch couples to the coupling of the vehicle hitch. The guide assembly of the present invention may be attached and interchanged between a vehicle hitch having a ball mount with a rise above the receiver and a vehicle hitch having a ball mount with a drop below the receiver.

### FIELD OF THE INVENTION

This invention relates generally to a trailer hitch and more particularly relates to a trailer hitch guide that effectively elevates and guides a forward end of a trailer tongue into coupling engagement with a receiver hitch of a towing vehicle. The trailer hitch guide assembly of the present invention includes a ramp and support arm, wherein the forward end of the trailer hitch travels up the ramp. As the forward end of the trailer hitch travels up the ramp, the forward end of the trailer hitch is elevated. The trailer hitch guide assembly of the present invention further guides the forward end of the trailer hitch into alignment with a coupling of the vehicle hitch, until the forward end of the trailer hitch engages a portion of the support arm. When the trailer hitch engages the support arm, the ramp disengages and the coupler of the trailer hitch couples to the coupling of the vehicle hitch. The trailer hitch guide assembly of the present invention mounts onto the conventional receiver hitch and coupling of the trailer tongue, without requiring welding or substantial modifications to the same.

### BACKGROUND OF THE INVENTION

Vehicles have been used to tow a wide variety of trailers for many years. For example, boat trailers, utility trailers, tent trailers, agricultural trailers, dual axle trailers, among others have all been towed by vehicles. A vehicle hitch and trailer coupling or hitch are commonly used to couple the vehicle to the trailer. Various devices have been developed to assist coupling the vehicle to the trailer. For ease of discussion, the coupling between a boat trailer and a truck will be described. Typically, the vehicle receiver hitch is mounted to a rearward portion of the truck frame and the trailer coupling is mounted to the tongue of the trailer. Vehicle receiver hitches are available that include a removable ball mount. The ball mount has one end that engages within the receiver hitch and the other end includes a drop or rise with an aperture extending through the end. A hitch ball includes a threaded bolt extending from the ball. Thus, the ball may be bolted to the ball mount through the aperture, with the ball mount oriented in the rise or drop position. The trailer coupling or hitch typically includes a socket that fits over the ball, and includes a latch that wraps under a portion of the ball to restrict removal of the ball from the socket.

When the load on the trailer is positioned over the axles of the trailer and/or the weight on the trailer is minimal, the tongue weight may be light enough for the user to elevate the tongue and pull the trailer into alignment and engagement with the vehicle hitch. However, the user may not always be able to elevate the tongue and pull the trailer into alignment with the vehicle hitch. Thus, in those instances, the vehicle must be maneuvered so that the hitch ball of the vehicle hitch aligns with the trailer hitch attached to the forward end of the tongue of the trailer.

When backing the towing vehicle towards the trailer, often times it is difficult for the driver to see both the forward end of the trailer tongue and the vehicle hitch. The inability to see both the forward end of the trailer tongue and the vehicle hitch may lead to misalignment and may require several attempts to align the vehicle hitch and trailer tongue. Once the trailer hitch and tongue are aligned, the bottom of the trailer hitch needs to be elevated above the hitch ball extending above the ball mount of the vehicle hitch. A jack attached to the tongue of the trailer has been used to elevate the tongue of the trailer.

U.S. Pat. No. 5,503,422 issued to Austin describes a hitch alignment apparatus that mounts underneath the drawbar or ball mount of the vehicle hitch. The hitch alignment apparatus includes a ramp and sides that guide and center the forward end of the trailer tongue until the forward end strikes a backing plate of the hitch alignment apparatus. The friction between the ramp and the trailer tongue is substantial and a significant force is required to force the trailer tongue up the ramp. Once the forward end of the tongue strikes the backing plate, the user then uses a jack to elevate the tongue above the ramp and then removes the hitch alignment apparatus from the ball mount. The user then lowers the trailer tongue until the coupling member of the trailer tongue engages the hitch ball of the vehicle hitch. The manual raising and lowering of the trailer tongue and the removal of the hitch alignment apparatus before coupling the trailer to the vehicle is time consuming and is not preferred.

U.S. Pat. No. 4,903,978 issued to Schrum, III recognizes that past devices have attempted to provide means for aligning the trailer socket and ball, however the past devices were indicated as too expensive to construct or too complicated to operate. Although Schrum III apparently describes a self-aligning trailer hitch, the hitch described by Schrum III also has shortcomings that are overcome by the present invention. Schrum III describes a trailer hitch having a ramp pivotally mounted to the ball mount oriented with a rise and a support element welded to the ball mount. The ramp requires doors that open when the ramp drops over the hitch ball. Rollers are attached to a forward side and upper forward end of a ball socket of the trailer tongue. The trailer hitch described by Schrum III is not operable with a trailer mount oriented with a drop. Further, when the tongue weight exceeds a certain amount, the roller assembly described by Schrum III is likely to rotate upward causing the bottom of the coupling to scrape along the ramp. Also, if the trailer and vehicle are not on an even surface, for example, if the vehicle is on a flat portion and the trailer is on a slight incline, the rollers described by Schrum III may prove ineffective and the bottom of the coupling may come into direct contact with the ramp, thereby substantially increasing the force required to force the coupling up the ramp. Thus, a need exists for a trailer hitch guide that effectively elevates and guides a forward end of the trailer hitch into coupling engagement with a receiver hitch of a towing vehicle, wherein the guide is operable with a ball mount oriented with a rise or drop, and wherein friction between the guide and trailer tongue is reduced. The present invention meets these and other needs that will become apparent from a review of the description of the present invention.

### SUMMARY OF THE INVENTION

The present invention provides a trailer hitch guide assembly for self-aligning a vehicle hitch to a coupler attached to the forward end of the tongue of a trailer (herein generally referred to as “the trailer coupling” or “the trailer hitch”). The guide assembly of the present invention includes a base, a ramp, a support arm, and wheels attached to a forward end of the trailer hitch. Without limitation, in the preferred embodiment, the trailer hitch includes a coupling and the vehicle hitch includes a ball, wherein the coupling of the trailer hitch couples to the ball of the vehicle hitch. The ball is attached to a ball mount, wherein the ball mount engages within a receiver of the vehicle hitch and extends therefrom.

The ball mount may have a rise or drop from the receiver of the vehicle hitch. The base of the guide assembly is attached to the ball mount in either a rise or drop orientation. The ramp has a proximal and a distal end, wherein the proximal end is pivotally attached to the base. Likewise, the support arm has a proximal and distal end, wherein the proximal end of the support arm is pivotally attached to the base and separated a distance from the proximal end of the ramp.

In the preferred embodiment, the wheels are rotatably attached to a frame, a portion of which attaches under a forward end of the trailer hitch, such that the wheel axel aligns or is under the bottom of the forward end of the trailer hitch. A lip member extends upward from the forward end of the trailer hitch for engaging the support arm. Those skilled in the art will appreciate that a hub for the wheels and the lip could be attached directly to the forward end of the trailer hitch, thereby eliminating the frame. However, a frame that quickly mounts to the trailer hitch is preferred. Further, the frame may include a ledge that engages a bottom of the forward end of the trailer hitch, thereby limiting upward rotation of the frame when the wheels engage the ramp.

In use, the base is mounted to the ball mount and the frame is mounted to the trailer hitch. The user pivots the distal ends of the ramp and support arm towards each other until a pin extending from a side of the ramp slides into a groove formed in the support arm. After the trailer wheels have been blocked to restrict the trailer from rolling backwards, the user backs the vehicle towards the trailer hitch. The ramp sides guide the forward end of the trailer hitch, thereby self centering the trailer hitch over the hitch ball mounted to the vehicle hitch.

As the vehicle moves backwards, the forward end of the trailer hitch engages the ramp, and the wheels attached to the forward end of the trailer hitch roll up the ramp, thereby lifting the forward end of the trailer hitch. As the vehicle continues backwards, the lip extending upward from the forward end of the trailer hitch engages the support arm and pushes the support arm out of engagement with the ramp. As the ramp and support arm disengage, the forward end of the trailer hitch lowers onto the hitch ball of the vehicle hitch and the trailer hitch coupling couples to the hitch ball of the vehicle hitch. In this manner, the trailer hitch guide of the present invention effectively elevates and guides a forward end of the trailer hitch into coupling engagement with the vehicle hitch. The trailer may be towed without removing the ramp or, alternatively, the ramp may be removed, inverted and re-mounted to the base in its storage position.

These and other advantages of the present invention will become readily apparent to those skilled in the art from a review of the following detailed description of the preferred embodiment especially when considered in conjunction with the claims and accompanying drawings in which like numerals in the several views refer to corresponding parts.

### DESCRIPTION OF THE DRAWINGS

FIG. 1 is a front perspective view of a trailer coupler engaged and coupled to a hitch ball of the vehicle hitch with the hitch guide of the present invention mounted to the ball mount;

FIG. 2 is a partial fragmentary bottom plan view of the trailer coupler of the type shown in FIG. 1, removed from the trailer tongue;

FIG. 3 is a partial fragmentary side elevational view of the trailer coupler or hitch in contact with the ramp of the trailer hitch guide of the present invention;

FIG. 4 is a partial fragmentary side elevational view of the trailer hitch in an elevated position from that shown in FIG. 3 and disengaging the support arm from the ramp;

FIG. 5 is a partial fragmentary side elevational view of the trailer hitch coupled to the hitch ball;

FIG. 6 is a partial fragmentary side elevational view of the trailer hitch coupled to the hitch ball with the ramp inverted in the stowed position, wherein the ball mount is oriented with a drop; and

FIG. 7 is a front perspective view of the ramp disengaged from the support arm with the trailer coupler shown elevated above the ramp for clarity.

### DETAILED DESCRIPTION

The present invention represents broadly applicable improvements to a trailer hitch guide. The embodiments detailed herein are intended to be taken as representative or exemplary of those in which the improvements of the invention may be incorporated and are not intended to be limiting. For purposes of discussion, and without any limitation intended, the trailer hitch guide of the present invention will be described in conjunction with a class III receiver hitch of known suitable construction. Those skilled in the art will appreciate that the trailer hitch guide of the present invention may be utilized with a variety of other available trailer hitches.

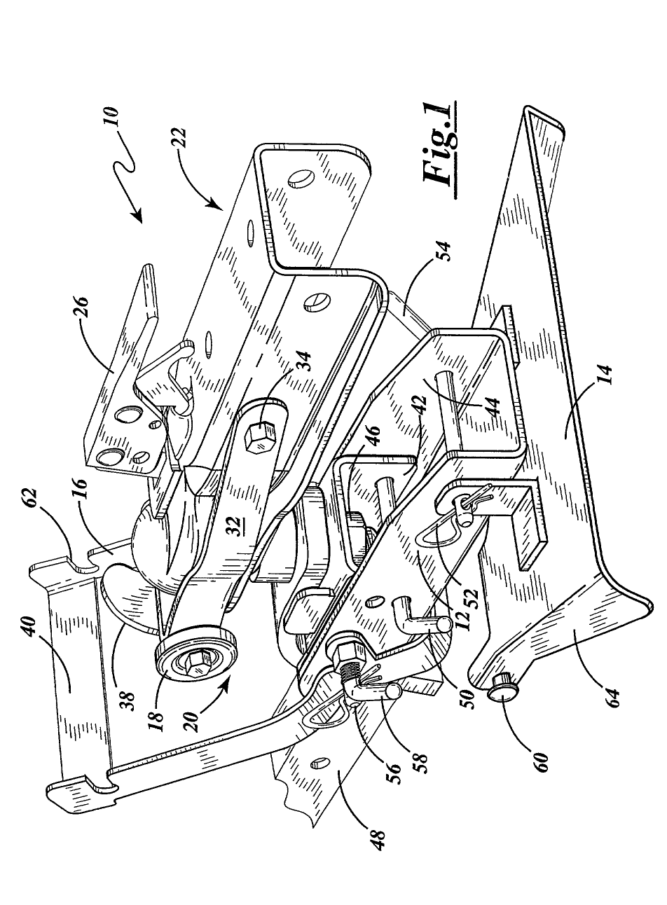

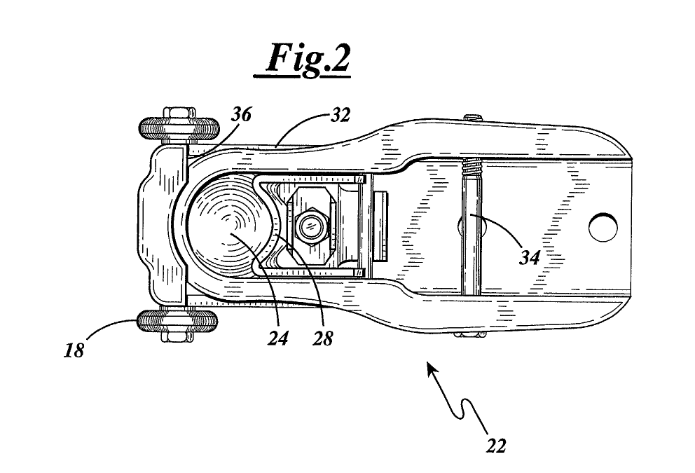

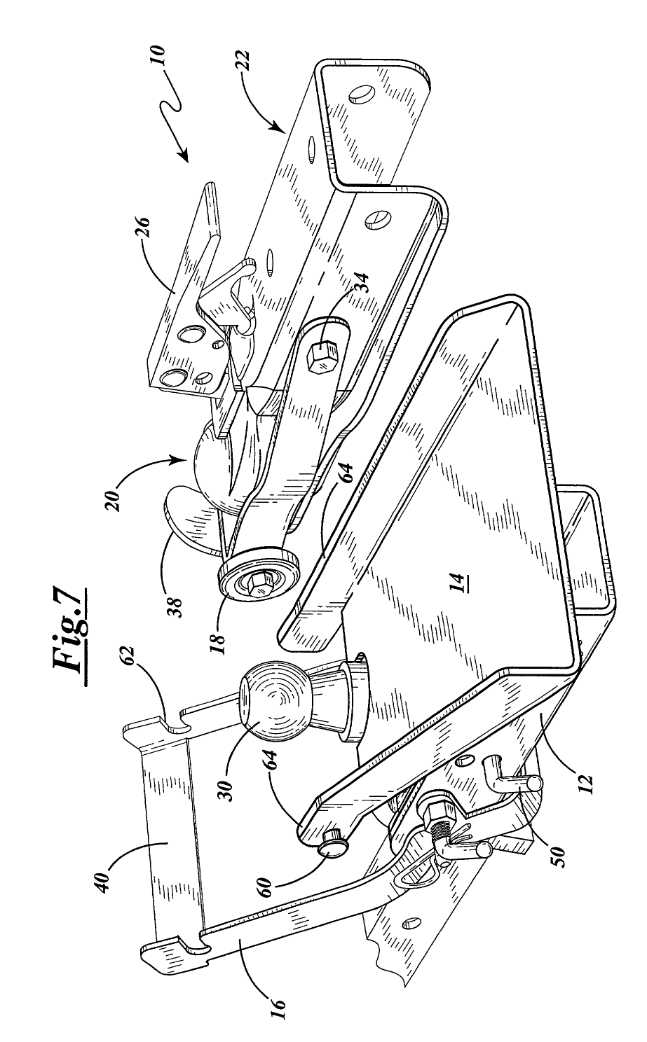

Referring first to FIGS. 1 and 7, there is shown generally a trailer hitch guide assembly 10 of the present invention. The trailer hitch guide assembly 10 of the present invention includes a base 12, a ramp 14, a support arm 16, and wheels 18 attached to a forward end 20 of a trailer coupler or hitch 22. Those skilled in the art will appreciate that the wheels may be constructed from metal or a durable plastic such as nylon, for example without limitation. The wheels 18 may be radiused (see FIG. 2) to further reduce the friction between the wheels 18 and ramp 14. The trailer coupler 22 shown in FIG. 1 is of known suitable construction and includes a socket 24 formed in the end and a hold down assembly 26 that includes a latch 28 that wraps under a portion of the ball 30 to restrict removal of the ball 30 from the socket 24 (see FIG. 2). A frame 32 is mounted to the trailer coupler 22, with a bolt 34 extending through bores formed in the side of the trailer coupler 22. The bore is often times pre-existing in a trailer coupler 22 of known suitable construction, however, those skilled in the art will recognize that the bores for the bolt 34 may be drilled into the sidewalls of the trailer coupler 22. A ledge 36 extends from the frame under a bottom of the forward end of the trailer coupler or hitch 22. Of course, the ledge does not extend so far under the bottom of the trailer coupler 22 to thereby block the opening to socket 24. The ledge 36 hooks and engages the bottom of the trailer coupler 22 to limit upward rotation of the frame 32 when the wheels 18 engage the ramp 14. The frame further includes a lip member 38 extending upward from a forward end of the frame 32. As the forward end of the trailer coupler 22 advances up the ramp 14, the lip member 38 engages a crossbar 40 of the support member 16.

The base 12 includes an upper plate 42 and lower plate 44. The upper plate 42 includes a bore through which the threaded shaft of the hitch ball 30 extends. The nut 46 of the hitch ball is turned onto the threaded shaft and tightened, thereby securing the upper plate 42 and hitch ball 30 to the ball mount 48. The lower plate 44 is fastened to the upper plate 42 with a hitch pin 50. An upper and lower bore are formed in the lower plate 44 to allow vertical adjustment of the lower plate 44 relative to the upper plate 42. In this manner various sized trailer couplers may be utilized with a simple change of the hitch pin 50 between the upper and lower bore. In this manner, sufficient clearance is provided between the lower plate 44 and the trailer coupler 22, when the trailer coupler 22 is engaged to the hitch ball 30. The clearance allows the trailer tongue to rotate in three dimensions both left to right and up and down without contacting the lower plate 44. Thus the trailer may be pulled over uneven terrain without the trailer coupling 22 bottoming out on the lower plate 44.

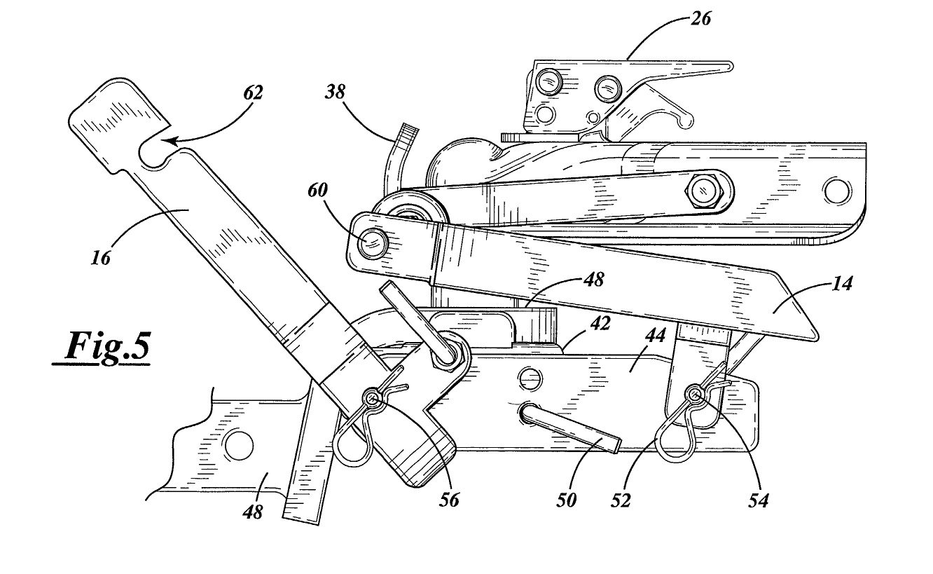

A hitch pin 54 is used to pivotally attach the proximal end of the ramp 14 to the lower plate 44 of the base 12. Similarly, a hitch pin 56 is used to pivotally attach the proximal end of the support arm 16 to the lower plate 44 of the base 12. A spring clip 52 inhibits the hitch pins 50, 54 and 56 from pulling out of the respective bore. Use of hitch pins 50, 54, and 56 and spring clips 52 further provides for quick assembly and disassembly of the trailer hitch guide assembly 10. A hold down angle bolt 58 may be tightened to secure the support arm 16 against the lower plate 44 in the stowed position (see FIG. 5). When the hold down angle bolt is loosened and the distal ends of the support arm 16 and ramp 14 are pivoted towards each other, a pin 60 extending from a side 64 of the ramp 14 engages within a groove 62 formed in the support arm 16.

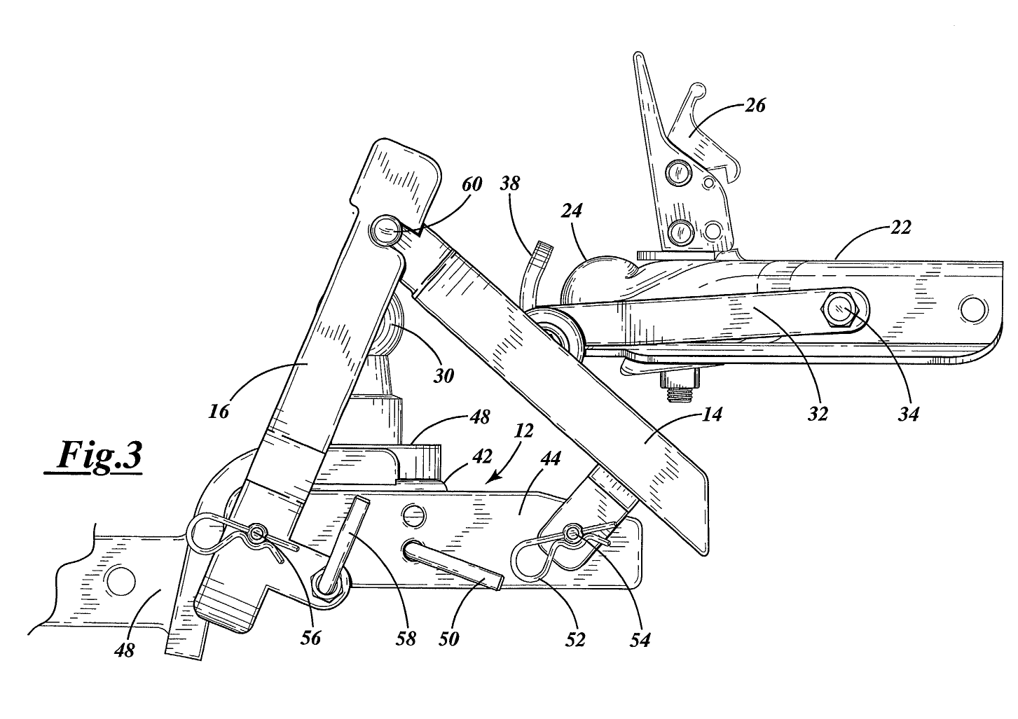

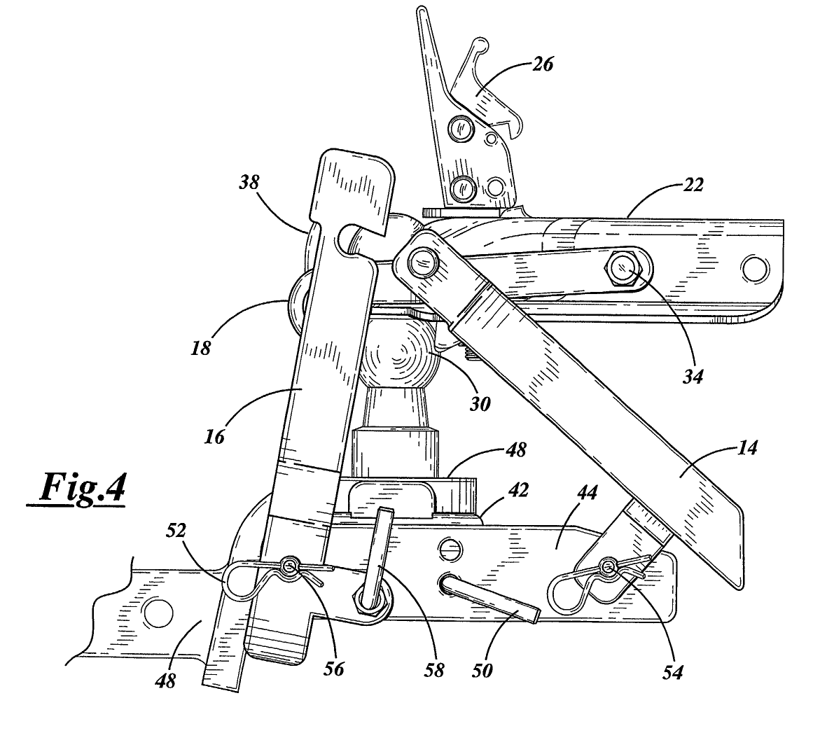

Having described the constructional features of the present invention the mode of use will be described in greater detail in conjunction with FIGS. 3-6. In use, the upper plate 42 of the base 12 is mounted to the ball mount 48 and the frame 32 is mounted to the trailer coupler or hitch 22. The lower plate 44 of the base 12 is mounted to the upper plate 42 and then the ramp 14 and support arm 16 are pivotally attached to the lower plate 44. The user then pivots the distal ends of the ramp 14 and support arm 16 towards each other until pins 60 extending from the sides 64 of the ramp 14 slides into groove 62 formed in the support arm 16, as shown in FIG. 3. When the user is ready to couple the trailer hitch to the vehicle, the user first blocks the trailer wheels to restrict the trailer from rolling backwards. The tongue is raised to a height slightly above the height of the bottom of the ramp 14. The user then backs the vehicle towards the front end of the tongue of the trailer. As the user continues to drive the vehicle backwards, the wheels 18 roll up the ramp 14 and the ramp sides 64 guide the trailer coupler 22 into alignment over the hitch ball 30.

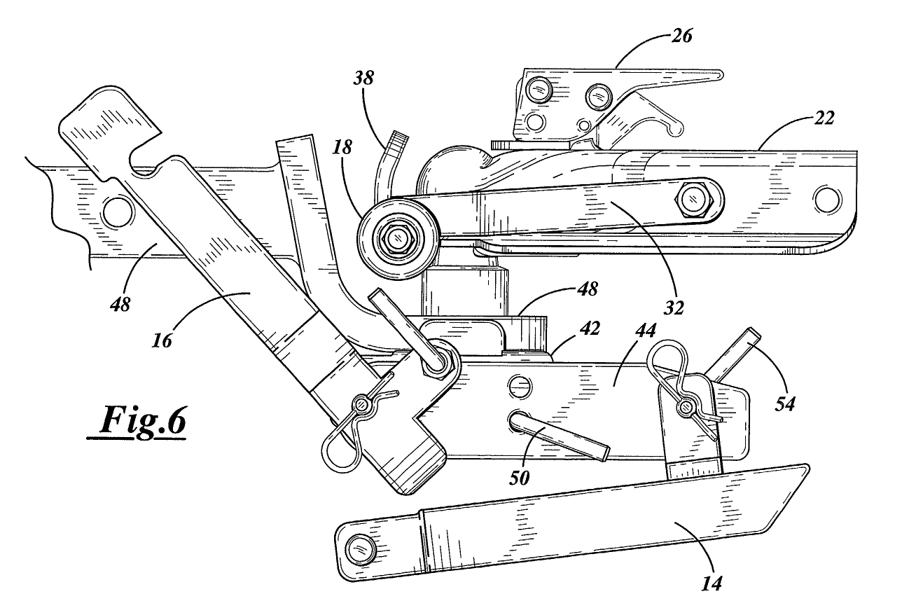

As the vehicle continues to move backwards, the forward end of the trailer continues to move up the ramp 14, thereby lifting the forward end of the trailer. As the vehicle continues backwards, the lip 38 extending upward from the frame 32 engages the crossbar 40 of the support arm 16 and pushes the support arm 16 out of engagement with the ramp 14. As the ramp 14 and support arm 16 disengage, the socket 24 of the trailer coupler 22 lowers onto the hitch ball 30. The hold down assembly 26 may be pivoted downward to engage and lock the latch 26 under a portion of the hitch ball 30 (see FIG. 5). In this manner, the trailer hitch guide assembly 10 of the present invention effectively elevates and guides a forward end of the trailer coupler 22 into coupling engagement with the vehicle hitch. The trailer may be towed without removing the ramp 14 or alternatively, the ramp 14 may be removed, inverted and re-mounted to the lower plate 44 of the base 12 in its storage position (see FIG. 6). Of course, those skilled in the art will appreciate that the vehicle hitch may alternatively be mounted to the front end of the vehicle frame and the trailer hitch guide assembly 10 may be mounted thereto.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A trailer hitch guide assembly for self-aligning a vehicle hitch that couples to a trailer hitch, said guide assembly comprising:
a ramp having a proximal and distal end, said proximal end of said ramp includes a first pivot;
a support arm having a proximal and distal end, said proximal end of said support arm includes a second pivot, wherein the first and second pivots are separated by a distance; and
a frame having wheels rotatably attached thereto, said frame attached to a forward end of the trailer hitch wherein an axle of said wheels is positioned adjacent a bottom portion of said trailer hitch.

2. The trailer hitch guide as recited in claim 1, wherein said frame includes a lip member extending upward from a forward end of the frame for engaging the support arm.

3. The trailer hitch guide as recited in claim 1, wherein said frame includes a ledge that engages a bottom of the forward end of the trailer hitch thereby limiting upward rotation of the frame when the wheels engage the ramp.

4. The trailer hitch guide as recited in claim 1, further including a base attached to said vehicle hitch and extending outwardly from said vehicle hitch, wherein said ramp and said support arm are pivotally attached to said base.

5. The trailer hitch guide as recited in claim 4, wherein said ramp may be attached to said base in an upright position for engagement to said support arm, and may be attached to said base in an inverted position for stowage.

6. The trailer hitch guide as recited in claim 1, wherein said vehicle hitch includes a ball extending from a ball mount and the forward end of said trailer hitch includes a coupler that couples to said ball of said vehicle hitch.

7. The trailer hitch guide as recited in claim 6, wherein said first pivot of said ramp is positioned rearward of said ball and said second pivot of said support arm is positioned forward of said ball.

8. The trailer hitch guide as recited in claim 1, wherein the trailer hitch guide is attachable to the vehicle hitch having a receiver and ball mount, wherein the ball mount has a rise from the receiver of the vehicle hitch.

9. The trailer hitch guide as recited in claim 1, wherein the trailer hitch guide is attachable to the vehicle hitch having a receiver and ball mount, wherein the ball mount has a drop from the receiver of the vehicle hitch.

10. A trailer hitch guide assembly for self-aligning a vehicle hitch that couples to a trailer hitch, said guide assembly comprising:
a base attached to said vehicle hitch and extending outwardly from said vehicle hitch;
a ramp having a proximal and distal end, said proximal end being pivotally attached to said base;
a support arm having a proximal and distal end, said proximal end being pivotally attached to said base and separated a distance from the proximal end of said ramp; and
wheels rotatably attached to a forward end of said trailer hitch.

11. The trailer hitch guide as recited in claim 10, wherein said trailer hitch includes a lip member extending upward from the forward end of the trailer hitch for engaging the support arm attached to the base.

12. The trailer hitch guide as recited in claim 10, wherein said wheels are rotatably attached to a frame having a ledge that engages a bottom of the forward end of the trailer hitch thereby limiting upward rotation of the frame when the wheels engage the ramp.

13. The trailer hitch guide as recited in claim 10, wherein said ramp may be attached to said base in an upright position for engagement to said support arm and may be attached to said base in an inverted position for stowage.

14. The trailer hitch guide as recited in claim 10, wherein said vehicle hitch includes a ball extending from a ball mount and the forward end of said trailer hitch includes a coupler that couples to said ball of said vehicle hitch.

15. The trailer hitch guide as recited in claim 14, wherein a pivot point of said ramp is rearward of said ball and a pivot point of said support arm is forward of said ball.

16. The trailer hitch guide as recited in claim 10, wherein the trailer hitch guide is attachable to the vehicle hitch having a receiver and ball mount, wherein the ball mount has a rise from the receiver of the vehicle hitch.

17. The trailer hitch guide as recited in claim 10, wherein the trailer hitch guide is attachable to the vehicle hitch having a receiver and ball mount, wherein the ball mount has a drop from the receiver of the vehicle hitch.

18. The trailer hitch guide as recited in claim 10, wherein the distal end of said ramp engages the distal end of said support arm and disengages when the forward end of said trailer hitch engages a portion of said support arm.
